(19) United States
(12) Patent Application Publication
(10) Pub. No.: US 2010/0079986 A1
(43) Pub. Date: Apr. 1, 2010

(54) Transparent Light-influencing Plate and a Luminaire with Such a Plate

(75) Inventor: Gerald Ladstaetter, Klaus (AT)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Zumtobel Lighting GmbH, Dornbim (AT)

(21) Appl. No.: 12/518,254

(22) PCT Filed: Sep. 17, 2007
(86) PCT No.: PCT/EP2007/008092

§ 371 Date: Jul. 9, 2009

(30) Foreign Application Priority Data
Dec. 8, 2006 (DE) 20 2006 018 617.4

(51) Int. Cl. F21S 4/00; F21S 8/10; F21V 5/04

(52) U.S. Cl. 362/223; 362/317; 362/335

(57) ABSTRACT

A light-influencing plate for a luminaire is made from transparent material and has wave progressions, which form a wavy structure, on one side and parallel light-damping or light-impermeable strips on the other side. The strips run transversely with respect to the wave progressions.

The invention relates to a transparent light-influencing plate that comprises a wavelike structure on one side.

Such light-influencing plates are used for example in luminaires with elongated light sources (WO 92/18805). The wave structure of the light-influencing plate causes the structure of the light source to be resolved to a great extent and to become no longer recognizable, if the luminaire is viewed laterally from the light source and in fact transversely with regard to its longitudinal direction.

There are also measures to resolve the structure of the elongated light source in a luminaire if the luminaire is viewed from one direction which extends in parallel with the longitudinal direction of the light source. Such a measure resides for example in the fact that a perforated plate is disposed upstream of the light source (EP 1 255 950 B1) and said perforated plate comprises elongated holes which extend in the longitudinal direction of the light source.

The object of the invention is to find an alternative solution for the perforated plate which guarantees that the structure of the elongated light source is resolved regardless from which side and in which direction the luminaire is viewed.

The solution resides in a transparent light-influencing plate with the features of claim 1.

The new light-influencing plate combines the characteristics of the hitherto known light-influencing plate and the perforated plate. In addition, the new light-influencing plate must be positioned—as was hitherto also the known light-influencing plate—upstream of the elongated light source so that the wave progressions extend in parallel with the longitudinal direction of the elongated light source.

The wavelike structure can be formed—viewed in cross-section—from wave peaks which include between the peaks essentially tapered or planar wave troughs. The wave peaks can be formed—likewise viewed in cross-section—in the shape of a segment of a circle. This means that they form sections of cylinder lenses which extend even in the longitudinal direction with a corresponding optical effect.

In order to take into consideration the light intensity of the elongated light source or lamp which reduces as the distance increases, it is also proposed that the width of the strips reduces transversely with regard to their longitudinal direction from the center of the plate towards its edge and/or that the distance of the strips transversely with regard to their longitudinal direction increases from the center of the plate towards its edge.

The plate can comprise glass or synthetic material.

A preferred option for attaching the strips to the plate resides in imprinting the strips thereon.

The light-influencing plate in accordance with the invention can also be produced by virtue of the fact that a lenticular film is applied to one side of a transparent base element which is planar on both sides and the said lenticular film forms the wave structure. Lenticular films are used in particular in 3D-flip image technology and are commercially available.

The lenticular film can also be the carrier for the strips. For this purpose, the strips can preferably be imprinted on the lenticular film.

The invention also relates to a luminaire in accordance with claim 11.

An exemplified embodiment of the invention is described hereinunder [with reference to] the following drawings, in which:

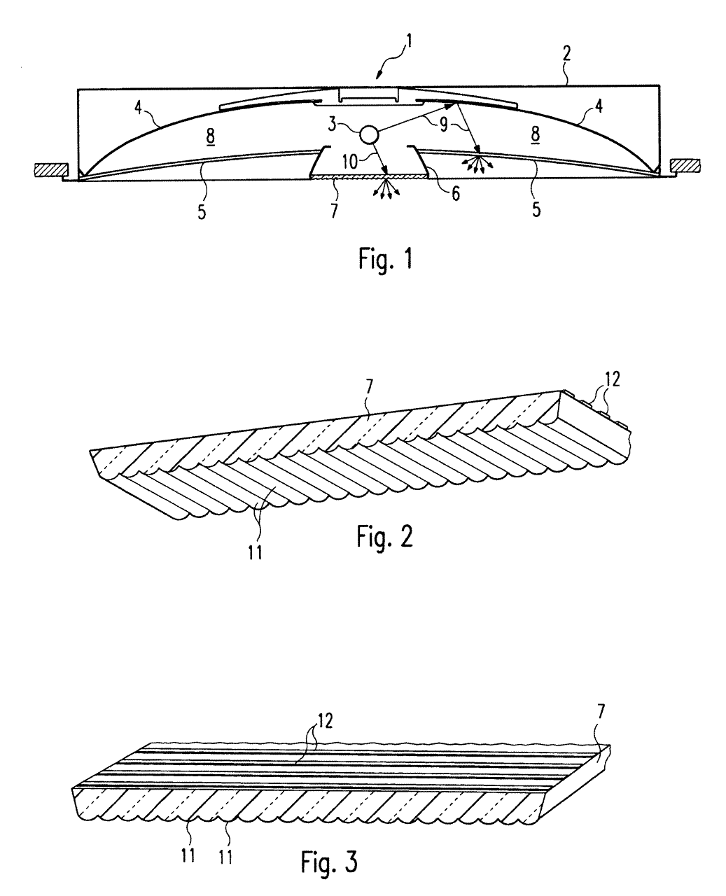

FIG. 1 shows a cross-sectional view through a luminaire with the light-influencing plate in accordance with the invention;

FIG. 2 shows a perspective illustration of a section of the light-influencing plate in accordance with the invention;

FIG. 3 shows a further perspective illustration of the light-influencing plate illustrated in FIG. 2.

The luminaire 1 illustrated in FIG. 1 is accommodated in a housing 2. The luminaire comprises an elongated light source in the form of a fluorescent lamp 3. A two-winged reflector 4 extends behind the fluorescent lamp 3 and together with two diffuser discs 5 forms two light chambers 8 which lie to the side of the fluorescent lamp 3. A light-influencing plate 7 is disposed—viewed from the radiated side—in the middle of the luminaire 1 upstream of the fluorescent lamp 3.

Two light beams 9 and 10 emitted by the fluorescent lamp 3 are illustrated in FIG. 1. The light beam 9—emitted by the fluorescent lamp 3—extends initially such that it is directed towards the one reflector wing 4 and is reflected therefrom in the direction of the associated diffuser plate 5. The reflected light beam 9 is then scattered onto the diffuser plate 5. The second light beam 10 falls from the fluorescent lamp 3 directly on the light-influencing plate 7 and is likewise scattered. This means, that the light-influencing plate 7 acts as a diffuser.

The light influencing plate 7 is illustrated more precisely in FIGS. 2 and 3. It comprises a transparent material, such as for example glass or synthetic material. The light-influencing plate 7 is provided on the lower side with a wave structure which is formed by wave progressions 11. The wave progressions have a profile in the shape of a segment of a circle and abut pointedly against each other, so that corresponding wave troughts are formed. On the upper side the light-influencing plate comprises light-damping or light-impermeable strips 12 which extend transversely with respect to the wave progressions 11.

The strips 12 are illustrated in FIGS. 2 and 3 such that they extend in parallel and have an identical width and identical spacing. However, it is possible and expedient to tailor the strip width and the spacing of the strips to suit the distance from the fluorescent tube 3 in order to take into account the light intensity which reduces as the distance from the fluorescent lamp 3 increases. For this purpose, the width of the strips 12 can be reduced from the center of the light-influencing plate towards the edge. Alternatively or cumulatively therewith, the distance of the strips 12 from the center of the light-influencing plate 7 towards its sides can be increased.

The light-influencing plate 7 illustrated in FIGS. 2 and 3 is a single part. However, it is also possible (and is not illustrated) that the light-influencing plate comprises a planar, transparent plate-shaped base element and a lenticular film which is attached to one side thereof and forms the wave structure. The strips 12 can in this case be imprinted on the flat side of the lenticular structure or they can be applied in a different manner. Alternatively thereto, it is, however, also naturally possible to attach the strips on the planar, transparent base element.

The essential function of the light-influencing plate 7 is that the structure of the fluorescent lamp 3, both when viewing the luminaire from the side, i.e. transversely with respect to the lamp longitudinal direction, and also from the front or the rear, i.e. in the lamp longitudinal direction is resolved, such that it is not or almost no longer recognizable.

1. Transparent light-influencing plate having two sides that comprises on one side a wavelike structure,
wherein
the other side of the plate is provided with light-damping or light-impermeable strips that extend essentially in parallel with respect to each other and overall essentially transversely with respect to the wave progressions.

2. Light-influencing plate as claimed in claim 1,
wherein
the wavelike structure—seen in cross-section—is formed by wave peaks that include between themselves essentially tapering or planar wave troughs.

3. Light-influencing plate as claimed in claim 2,
wherein
the wave peaks—seen in cross-section—are formed in the shape of a segment of a circle.

4. Light-influencing plate according to claim 1, wherein
the width of the strips reduces transversely with respect to their longitudinal direction from the center of the plate towards its edge.

5. Light-influencing plate as claimed in claim 1, wherein
the distance of the strips transversely with respect to their longitudinal direction increases from the center of the plate towards its edge.

6. Light-influencing plate as claimed in claim 1, wherein
the plate comprises glass or synthetic material.

7. Light-influencing plate as claimed in claim 1, wherein
the strips are imprinted on the plate.

8. Light-influencing plate as claimed in claim 1, wherein
the plate comprises a base element, which is planar and transparent on both sides, and a lenticular film that is applied to one side thereof, the lenticular film forming the wave structure.

9. Light-influencing plate as claimed in claim 8, wherein
the lenticular film is the carrier for the strips.

10. Light-influencing plate as claimed in claim 9, wherein
the strips are imprinted on the lenticular film.

11. Luminaire with an elongated light source and a transparent light-influencing plate disposed upstream of the light source as claimed in claim 1, which is disposed in such a manner that the wave progressions extend in the longitudinal direction of the light source.
